(19) United States
(12) Patent Application Publication
(10) Pub. No.: US 2017/0274513 A1
(43) Pub. Date: Sep. 28, 2017

(54) FASTENER DRIVING APPARATUS

(71) Applicants: Christopher Pedicini, Franklin, TN (US); John Witzigreuter, Canton, GA (US)

(72) Inventors: Christopher Pedicini, Franklin, TN (US); John Witzigreuter, Canton, GA (US)

(73) Assignee: Tricord Solutions, Inc., Franklin, TN (US)

(21) Appl. No.: 15/471,915

(22) Filed: Mar. 28, 2017

Related U.S. Application Data
(63) Continuation-in-part of application No. 15/338,433, filed on Oct. 30, 2016.
(60) Provisional application No. 62/314,187, filed on Mar. 28, 2016.

(51) Int. Cl. B25C 1/06; B25C 1/00; B25C 1/04

(52) U.S. Cl. CPC B25C 1/06; B25C 1/047; B25C 1/003

(57) ABSTRACT

A fastener driving apparatus comprises an energy storage means, a drive mechanism, and an anvil assembly. The drive mechanism selectively engages the energy storage means to store potential energy within the energy storage means. After the drive mechanism disengages, potential energy previously stored within the energy storage means impart a force on the anvil assembly to launch the assembly (and incorporated anvil) to drive a fastener. The drive mechanism may comprise a cam for engaging and disengaging the energy storage means. The apparatus may also comprise a nail indexing mechanism for supplying fasteners, which indexing mechanism may also be acted and operated on by the cam. The apparatus may further comprise a gas spring as a return mechanism for returning the anvil assembly to a position after the anvil assembly has separated from the energy storage means.

### CROSS REFERENCE TO RELATED APPLICATIONS

The present disclosure claims priority under 35 U.S.C. §120 on and is a continuation-in-part of pending U.S. patent application Ser. No. 15/338,433, filed on Oct. 30, 2016, the disclosure of which is incorporated by reference. The present disclosure also claim priority under 35 U.S.C. §119 on pending U.S. Provisional Application Ser. No. 62/314,187, filed on Mar. 28, 2016, the disclosure of which is incorporated by reference

### FIELD OF THE DISCLOSURE

The present disclosure relates to fastener driving apparatuses, and, more particularly, to such fastener or staple driving mechanisms that require operation as a hand tool.

### BACKGROUND

Electromechanical fastener driving apparatuses (also referred to herein as a “driver,” “gun” or “device”) known in the art often weigh generally less than 15 pounds and may be configured for an entirely portable operation. Contractors and homeowners commonly use power-assisted devices and means of driving fasteners into wood. These power-assisted means of driving fasteners can be either in the form of finishing fastener systems used in baseboards or crown molding in house and household projects, or in the form of common fastener systems that are used to make walls or hang sheathing onto same. These systems can be portable (i.e., not connected or tethered to an air compressor or wall outlet) or non-portable.

The most common fastener driving apparatus uses a source of compressed air to actuate a guide assembly to push a fastener into a substrate. For applications in which portability is not required, this is a very functional system and allows rapid delivery of fasteners for quick assembly. A disadvantage is that it does however require that the user purchase an air compressor and associated air-lines in order to use this system. A further disadvantage is the inconvenience of the device being tethered (through an air hose) to an air compressor.

To solve this problem, several types of portable fastener drivers operate off of fuel cells. Typically, these guns have a guide assembly in which a fuel is introduced along with oxygen from the air. The subsequent mixture is ignited with the resulting expansion of gases pushing the guide assembly and thus driving the fastener into the workpieces. This design is complicated and is far more expensive then a standard pneumatic fastener gun. Both electricity and fuel are required as the spark source derives its energy typically from batteries. The chambering of an explosive mixture of fuel, the use of consumable fuel cartridges, the loud report and the release of combustion products are all disadvantages of this solution. Systems such as these are already in existence and are sold commercially to contractors under the Paslode™ name.

Another commercially available solution is a fastener gun that uses electrical energy to drive a stapler or wire brad. Such units typically use a solenoid to drive the fastener (such as those commercially available under the Arrow™ name or those which use a ratcheting spring system such as the Ryobi™ electric stapler). These units are limited to short fasteners (typically 1″ or less), are subject to high reactionary forces on the user and are limited in their repetition rate. The high reactionary force is a consequence of the comparatively long time it takes to drive the fastener into the substrate. Additionally, because of the use of mechanical springs or solenoids, the ability to drive longer fasteners or larger fasteners is severely restricted, thus relegating these devices to a limited range of applications. A further disadvantage of the solenoid driven units is they often must be plugged into the wall in order to have enough voltage to create the force needed to drive even short fasteners.

A final commercially available solution is to use a flywheel mechanism and clutch the flywheel to an anvil that drives the fastener. Examples of such tools can be found under the Dewalt™ name. This tool is capable of driving the fasteners very quickly and in the longer sizes. The primary drawback to such a tool is the large weight and size as compared to the pneumatic counterpart. Additionally, the drive mechanism is very complicated, which gives a high retail cost in comparison to the pneumatic fastener gun.

Clearly based on the above efforts, a need exists to provide portable solution to driving fasteners which is unencumbered by fuel cells or air hoses. Additionally, the solution ought to provide a low reactionary feel, be able to drive full size fasteners and be simple, cost effective and robust in operation.

The prior art teaches several additional ways of driving a fastener or staple. The first technique is based on a multiple impact design. In this design, a motor or other power source is connected to an impact anvil through either a lost motion coupling or other device. This allows the power source to make multiple impacts on the fastener to drive it into the workpiece. The disadvantages in this design include increased operator fatigue since the actuation technique is a series of blows rather than a single drive motion. A further disadvantage is that this technique is relatively slow due to the multiple blows and because it requires the operator to continuously hold the device in position during the fastener drive process.

A second design that is taught in U.S. Pat. Nos. 3,589,588, 5,503,319, and 3,172,121 includes the use of potential energy storage mechanisms (in the form of a mechanical spring). In these designs, the spring is cocked (or activated) through an electric motor. Once the spring is sufficiently compressed, the energy is released from the spring into the anvil (or fastener driving piece), thus pushing the fastener into the substrate. Several drawbacks exist to this design. These include the need for a complex system of compressing and controlling the spring, and in order to store sufficient energy, the spring must be very heavy and bulky. Additionally, the spring suffers from fatigue, which gives the tool a very short life. Furthermore, metal springs must move a significant amount of mass in order to decompress, and the result is that these low-speed fastener drivers result in a high reactionary force on the user. Finally, the mass of the spring that is moving decreases the efficiency of the device as its kinetic energy is typically unavailable to use in driving the fastener.

To improve upon this design, an air spring has been used to replace the mechanical spring. U.S. Pat. No. 4,215,808 teaches of compressing air within a guide assembly and then releasing the compressed air by use of a gear drive. This patent overcomes some of the problems associated with the mechanical spring driven fasteners described above, but is subject to other limitations. One particular troublesome issue with this design is the safety hazard in the event that the anvil jams on the downward stroke. If the fastener jams or buckles within the feeder and the operator tries to clear the jam, he is subject to the full force of the anvil, since the anvil is predisposed to the down position in all of these types of devices. A further disadvantage presented is that the fastener must be fed once the anvil clears the fastener on the backward stroke. The amount of time to feed the fastener is limited and can result in jams and poor operation, especially with longer fasteners. A further disadvantage to the air spring results from the need to have the ratcheting mechanism as part of the anvil drive. This mechanism adds weight and causes significant problems in controlling the fastener drive since the weight must be stopped at the end of the stroke. This added mass slows the fastener drive stroke and increases the reactionary force on the operator. Additionally, because significant kinetic energy is contained within the air spring and piston assembly the unit suffers from poor efficiency. This design is further subject to a complicated drive system for coupling and uncoupling the air spring and ratchet from the drive train which increases the production cost and reduces the system reliability.

U.S. Pat. No. 5,720,423 again teaches of an air spring that is compressed and then released to drive the fastener. The drive or compression mechanism used in this device is limited in stroke and thus is limited in the amount of energy which can be stored into the air stream. In order to provide sufficient energy in the air stream to achieve good performance, this patent teaches use of a gas supply which preloads the guide assembly at a pressure higher than atmospheric pressure. Furthermore, the compression mechanism is bulky and complicated. In addition, the timing of the motor is complicated by the small amount of time between the release of the piston and anvil assembly from the drive mechanism and its subsequent re-engagement. Additionally, U.S. Pat. No. 5,720,423 teaches that the anvil begins in the retracted position, which further complicates and increases the size of the drive mechanism. Furthermore, because of the method of activation, these types of mechanisms as described in U.S. Pat. Nos. 5,720,423 and 4,215,808 must compress the air to full energy and then release off the tip of the gear while under full load. This method of compression and release causes severe mechanism wear. As will be discussed below, the present disclosure overcomes these and other limitations in the prior art use of air springs.

A third means for driving a fastener that is taught includes the use of flywheels as energy storage means. The flywheels are used to launch a hammering anvil that impacts the fastener. This design is described in detail in U.S. Pat. Nos. 4,042,036, 5,511,715, and 5,320,270. One major drawback to this design is the problem of coupling the flywheel to the driving anvil. This prior art teaches the use of a friction clutching mechanism that is both complicated, heavy and subject to wear. Further limiting this approach is the difficulty in controlling the energy in the fastener system. The mechanism requires enough energy to drive the fastener, but retains significant energy in the flywheel after the drive is complete. This further increases the design complexity and size of such prior art devices.

A fourth means for driving a fastener is taught in the present inventors' U.S. Pat. No. 8,079,504, which uses a compression on demand system with a magnetic detent. This system overcomes many of the advantages of the previous systems but still has its own set of disadvantages which include the need to retain a very high pressure for a short period of time. This pressure and subsequent force necessitate the use of high strength components and more expensive batteries and motors.

A fifth means is taught in pending U.S. Pat. No. 8,733,610, which uses a vacuum to drive a fastener drive assembly. This clearly has its own advantages over the previous systems but has its own set of disadvantages, including the need to retain a seal against air pressure and frictional losses of the seal during the fastener drive. This sealing requirement necessitates the use of more accurate cylinders and pistons, thus contributing to the manufacturing cost.

All of the currently available devices suffer from one or more the following disadvantages:
Complex, expensive and unreliable designs. Fuel powered mechanisms such as Paslode™ achieve portability but require consumable fuels and are expensive. Rotating flywheel designs such as Dewalt™ have complicated coupling or clutching mechanisms based on frictional means. This adds to their expense.
Poor ergonomics. The fuel powered mechanisms have loud combustion reports and combustion fumes. The multiple impact devices are fatiguing and are noisy.
Non-portability. Traditional fastener guns are tethered to a fixed compressor and thus must maintain a separate supply line.
High reaction force and short life. Mechanical spring driven mechanisms have high tool reaction forces because of their long fastener drive times. Additionally, the springs are not rated for these types of duty cycles leading to premature failure. Furthermore, consumers are unhappy with their inability seat longer fasteners or work with denser wood species.
Safety issues. The prior art “air spring” and heavy spring driven designs suffer from safety issues for longer fasteners since the predisposition of the anvil is towards the substrate. During jam clearing, this can cause the anvil to strike the operators hand.
The return mechanisms in most of these devices can take significant amounts of the drive energy and have short lives. A bungee or spring or combination of both is often used to return the anvil. Many of these elements suffer premature failure in this high stress application.

In light of these various disadvantages, there exists the need for a fastener driving apparatus that overcomes these various disadvantages of the prior art, while still retaining the benefits of the prior art.

### SUMMARY OF THE DISCLOSURE

In accordance with the present disclosure, a fastener driving apparatus is described which derives its power from an electrical source, preferably rechargeable batteries, and uses a motor and drive mechanism to store potential energy. After sufficient energy storage, the drive mechanism may disengage from the energy storage means and allow the energy storage means to accelerate an anvil assembly (which assembly comprises at least an anvil) to drive a fastener. A passive element such as a gas spring is used to bias the anvil assembly in position for another fastener drive.

In an embodiment the anvil assembly is biased towards a first position by a gas spring. It was unexpectedly discovered that the use of a gas spring to return the anvil assembly to a first position resulted in both an efficiency and life improvement. Heretofore, mechanical springs and bungees have been commonly used both separately and in tandem to return the anvil to a first position. These methods have resulted in either short life due to the springs taking a set or the bungee or elastomer breaking. By using a gas spring, we achieved a constant force return which had resetting characteristic for moving the anvil to a first position as well as a remarkably improved life.

In an embodiment, the energy storage means is at least one gas spring. In a still further embodiment, the gas spring has a limited stroke in comparison to the stroke of the anvil of the anvil assembly. By limiting the stroke of the gas spring in relation to the stroke of the anvil, we unexpectedly achieved higher efficiencies as the drag imposed by the seal on the piston was over a much shorter stroke. Additionally, we were able to generate sufficient energy to drive a fastener with only a small increase in pressure in the chamber or other environment in which the pistons are disposed. This unexpectedly increased the efficiency of the unit since heat of compression of a gas is a significant source of energy inefficiency. During the inventive process, it was also discovered that the mass differential greatly impacts the efficiency of the device. Ideally, the moving mass within the gas springs (primarily the pistons) is less than the moving (or eventually thrown) mass of the anvil and anvil assembly. It is to be understood that although the term piston is used throughout this specification, any element which pushes the anvil assembly away from a first position to a second position to drive the fastener is also contemplated.

In alternate embodiments, the energy storage means may comprise a mechanical spring or an elastomeric spring.

The fastener driving cycle of the apparatus disclosed herein may start with an electrical signal, after which a circuit connects a motor to the electrical power source. The motor is coupled to the gas springs through a drive mechanism. In an operational cycle of the drive mechanism, the mechanism alternatively (1) actuates the energy storage means (such as the pistons of the gas spring(s)) and (2) decouples from the energy storage means (such as the pistons). For example, during a portion of its cycle, the drive mechanism may move the pistons to increase potential energy stored within the energy storage means (such as the gas springs). In the next step of the cycle, the mechanism decouples from the energy storage means to allow the accumulated potential energy within the energy storage means to act on and actuate the pistons. The pistons thereupon move and cause the anvil assembly to move and have the anvil thereof drive a fastener. A spring or other return mechanism (such as a gas spring or elastomeric spring, for example) is operatively coupled to the anvil assembly to return the anvil and anvil assembly to a first position. In an embodiment, at least one bumper is disposed within the energy storage means (such as the gas springs) or outside energy storage means (such as the gas springs) to reduce the wear on the energy storage means (such as the pistons). In an embodiment another bumper is used to reduce the wear on the anvil assembly that otherwise may occur in operation of the fastener driving apparatus.

In an embodiment, the mass of the anvil and anvil assembly is at least equal to the moving mass of the energy storage means (such as a gas spring(s)), and more preferably, at least 1.2 times the moving mass of the gas springs, and still more preferably, 1.5 times the moving mass of the gas spring(s). In another embodiment, the mass of the piston is less than 50% of the mass of the anvil assembly.

In an embodiment, the stroke or movement of the pistons is less than one half the total movement of the anvil and anvil assembly. Further preferred is that the movement of the pistons results in a volume decrease within the gas springs of less than 20% of the initial volume (which thus reduces losses from heat of compression.)

In an embodiment, a sensor and a control circuit are provided for determining at least one position of the device to enable the proper timing for stopping the operational cycle of the apparatus. Further, this information can be used to detect a jam condition for proper recovery.

In an embodiment, the anvil and anvil assembly separate from the energy storage means prior to driving a fastener. In a further embodiment, the anvil and anvil assembly separate from the energy storage means prior to or within less than 50% of the total fastener stroke. This results in an improved safety profile in the event of a jam, as the anvil and anvil assembly will have dissipated its kinetic energy, thus allowing the user to fix the jam without having potential energy remaining in the anvil and anvil assembly.

In an embodiment, the energy storage means of the apparatus comprises more than one gas spring. In an exemplary embodiment, two gas springs are utilized, each of which spring may be disposed on opposite sides of the anvil assembly. This configuration may result in a more compact fastener driving device as the gas springs are able to be nested in parallel with the anvil assembly instead of on top of the anvil assembly. Another benefit is that the use of more than one gas spring allows for a smaller diameter piston, as the force required to actuate the piston is distributed over two gas springs. A smaller diameter piston is advantageous as guiding of the piston is improved and off axis loads can be minimized.

In an embodiment, a cam which is powered from the drive mechanism is used to index a nail feeding mechanism of the apparatus. Using the motion provided by the cam to index the nail or to cock a spring (or other storage element which is then used to index the nail in the fastener driving apparatus) greatly simplifies the design. The cam articulates a nail indexing linkage to position the fastener right beneath the anvil and/or anvil assembly before the anvil and/or anvil assembly is released to drive the nail. Framing nailers as well as finish nail guns typically use a spring to index a stick of nails and position them beneath the driver blade just in time for the anvil to strike and drive them into a substrate. However, some nailing devices require coil fed nails that must be actively indexed in order to be fed. In pneumatically-powered fastener drivers, this is done by compressed air driving a piston that indexes the nail. Using compressed air to index the nail in the present disclosure is not practical. Therefore, another solution is required.

In an embodiment, a locking mechanism (such as a one-way clutch) is used to provide an intermediate stopping point during which the gas spring(s) is/are being energized. This locking mechanism retains the drive mechanism in place once power is removed from the motor. This allows potential energy to be stored in the fastener driving apparatus. It also greatly reduces the latency between the time a user pulls a trigger of the apparatus and a fastener being driven into a substrate.

Accordingly, and in addition to the objects and advantages of the portable electric fastener gun as described above, several objects and advantages of the present disclosure are:
To provide a simple design for driving fasteners that has a significantly lower production cost than currently available nail guns and that is portable and does not require an air compressor.
To provide a fastener driving device that mimics the pneumatic fastener performance without a tethered air compressor.
To provide an electrical driven high power fastening device that has very little wear.
To provide an electric motor driven fastener driving device in which energy is not stored behind the fastener driving anvil, thus greatly enhancing tool safety.
To provide a more energy efficient mechanism for driving nails than is presently achievable with a compressed air design.
To provide a simplified means of indexing the nails in the fastener driving device.
To provide a means for reducing the time from cycle start to nail drive, thus greatly improving the user experience.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present disclosure will become better understood with reference to the following detailed description and claims taken in conjunction with the accompanying drawings, in which

FIG. 1 is a cutaway view of a fastener driving apparatus in a first operating position, in accordance with an exemplary embodiment of the present disclosure;

FIG. 2 is a cutaway view of a fastener driving apparatus in a second operating position with the anvil assembly separated from the energy storage means, in accordance with an exemplary embodiment of the present disclosure;

FIG. 3 is a view showing a gas spring as a return mechanism of a fastener driving apparatus for returning an anvil assembly) from a second position to a first position in accordance with an exemplary embodiment of the present disclosure; and

FIG. 4 is a view showing an indexing mechanism of a fastener driving apparatus for sequencing a nail, in accordance with an exemplary embodiment of the present disclosure.

Like reference numerals refer to like parts throughout the description of several views of the drawings.

### DETAILED DESCRIPTION OF THE DISCLOSURE

A best mode for carrying out the present disclosure is presented in terms of its preferred embodiment, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure. Furthermore, although the following relates substantially to one embodiment of the design, it will be understood by those familiar with the art that changes to materials, part descriptions and geometries can be made without departing from the spirit of the disclosure. It is further understood that references such as front, back or top dead center, bottom dead center do not refer to exact positions but approximate positions as understood in the context of the geometry in the attached figures.

The terms “a” and “an” herein do not denote a limitation of quantity, but rather denote the presence of at least one of the referenced items.

Referring also to the figures, the present disclosure provides for a fastener driving apparatus 100. In an embodiment, the apparatus 100 comprises a power source 10, a control circuit 20, a motor 30, an energy storage means (such as, in an embodiment, at least one spring 40), a drive mechanism 50, an anvil assembly 60 (which anvil assembly comprises an anvil 62) and a one-way clutch 54. The apparatus 100 may further comprise an anvil return mechanism 64 and at least one bumper 70. The at least one spring 40 is preferably a gas spring and includes a piston (or pushing element) 42, which piston 42 is at least partially disposed within a sealed chamber 44, and which piston 42 is selectively actuated by the drive mechanism 50. A bumper 72 is preferably disposed within the at least one gas spring 40 to absorb a portion of the force of impact of the piston 42. The at least one gas spring 40 further comprises a nose portion 46 (which nose portion may be a part of or coupled to the piston) and which nose portion 46 extends out of the chamber and which makes operative contact with the anvil assembly 60 during a portion of the operational cycle of the apparatus 100.

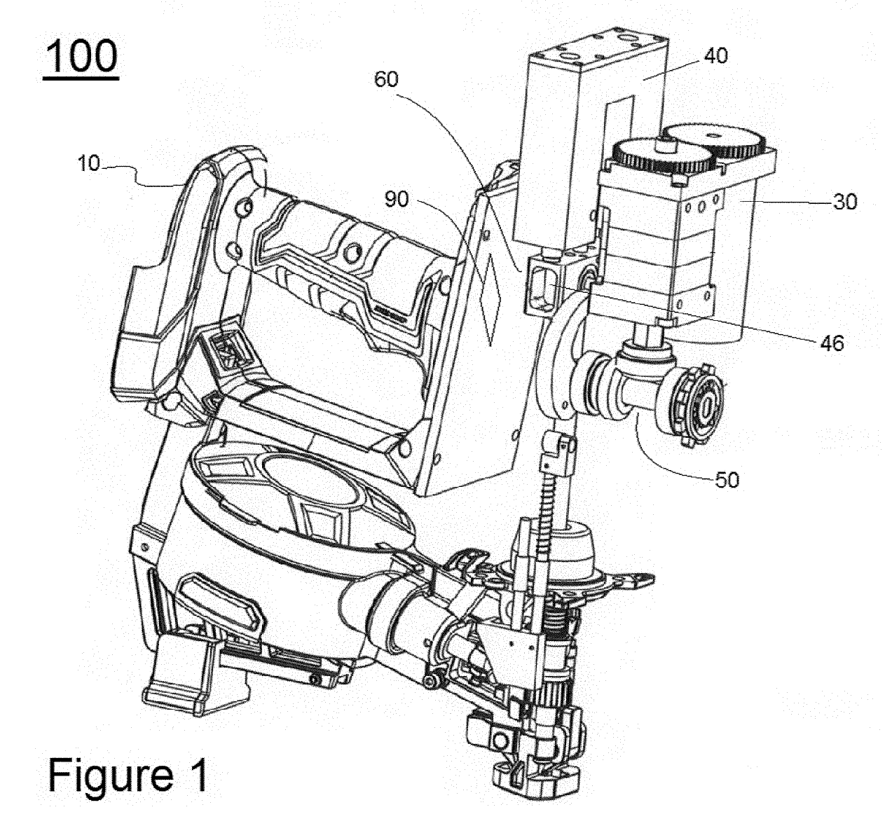

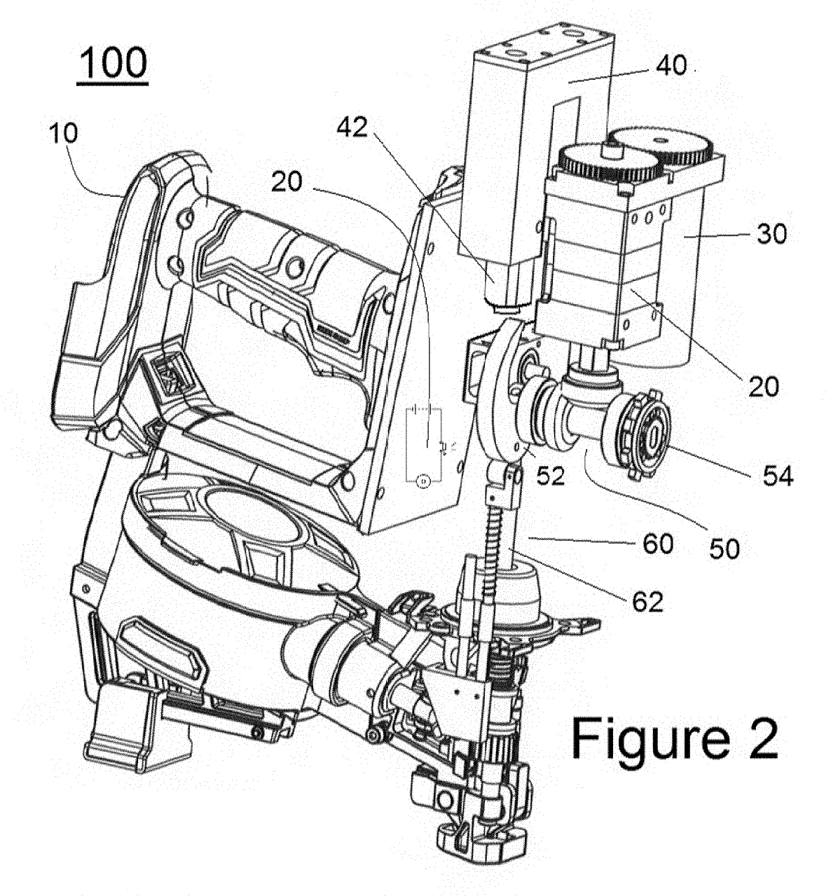

The drive mechanism 50 preferably comprises a cam-driven mechanism 52 as illustrated in FIGS. 1 and 2 although it is contemplated that any such arrangement which allows selective engagement and disengagement (such as an interrupted rack and pinion) may be used. It will be apparent that the drive mechanism 50 is configured to permit transition from engagement with the potential energy storage means (such as gas spring 40) to disengagement from the potential energy storage means (such as gas spring 40). The drive mechanism 50 is operatively coupled to the gas spring 40, and in a particular embodiment, to the piston 42 such that the drive mechanism 50 may alternate in actuating the piston 42 (when the cam is engaged, for example, and as shown in FIG. 1) and in refraining from applying a drive force on the piston (as shown in FIG. 2). A one-way clutch 54 is configured within the drive mechanism to allow the drive mechanism 50 to stop and retain the gas springs in an energized position prior to releasing the anvil assembly 60. It will be apparent that other devices for stopping and retaining the drive mechanism at an intermediate energized position may be provided—including, but not limited to, a wrap spring or ratchet and pall arrangement.

In an embodiment, the drive mechanism 50 engages and actuates the piston(s) 42 (and/or anvil assembly 60) to store potential energy within the gas spring(s) 40, which actuation of the piston(s) 42 may be referred to as an “energized position” of the piston(s) 42. In an embodiment, the initial pressure (before the drive mechanism 50 actuates the piston(s) 42) within the gas spring(s) 40 is at least 40 psia. The configuration and design of the gas spring 40 are such that the pressure increase during the piston movement is less than 40% of the initial pressure, and in an embodiment, less than 25% of the initial pressure, which allows the drive mechanism 50 to operate at a more constant torque, thus improving the motor efficiency. The drive mechanism 50 thereafter disengages the piston(s) 42 (and/or anvil assembly 60), allowing potential energy to act on the piston(s) 42 and cause the piston(s) 42 to move and act on the anvil assembly 60 (as will be described in further detail below). The drive mechanism 50 is timed and/or configured to prevent further engagement with the gas spring(s) 40 until after the anvil assembly 60 has returned to an approximate starting position. The drive mechanism 50 may thereafter again act on the piston(s) 42 to again store potential energy within the gas spring(s) 40 and may thereafter again temporarily cease to act on the piston(s) 42 (and/or anvil assembly 60) to allow potential energy to instead act on the pistons 42. In an embodiment, the stroke of the piston(s) 42 is less than stroke of the anvil assembly 60.

The anvil assembly 60 is operatively coupled to the gas spring(s) 40, such as to the piston(s) 42 or nose portion such that when the piston(s) 42 is released under pressure from the drive mechanism 50, the force from the piston(s) 42 is imparted onto the anvil assembly 60, causing the anvil assembly 60 to move in a direction and to release (or be launched) away from the piston(s) 42 and drive a fastener, for example. As shown in FIG. 2, the anvil assembly may separate from the energy storage means for a portion of the fastener drive stroke of the anvil assembly. It was discovered in the course of developing the disclosure that for the launched case that the ratio of the thrown mass to the moving mass within the gas spring(s) 40 (primarily the piston(s) 42) was exceedingly important to the efficiency of the fastener driving apparatus 100. It is preferred to have thrown mass (which in this case is the anvil assembly 60) that is greater than 50% of the total moving mass (anvil assembly mass+gas springs moving mass) and even more preferable to have the anvil assembly mass at least 60% of the total moving mass. This discovery allows the present disclosure to have increased efficiency in transferring the potential energy into driving energy on the fastener. In an embodiment, the mass of the anvil assembly 60 is at least two times the mass of the piston(s) 42. In an embodiment, the piston(s) 42 has a mass of about 30 grams and the anvil assembly 60 has a mass of about 160 grams. In an embodiment, the piston(s) 42 are hollowed out to reduce mass and further may be constructed of lightweight materials such as hard anodized aluminum, plastics or the like. The anvil assembly 60 may be operatively coupled to a guide, shaft, or other structure that limits and guides the range of motion of the anvil assembly 60.

A sensor 90 is provided for determining at least one position of the apparatus to enable the proper timing for stopping the operational cycle of the apparatus. Further, this information can be used to detect a jam condition for proper recovery.

At least one bumper 70 may be disposed on the apparatus 100 for absorbing a portion of the force of impact of the piston(s) 42 within the gas spring(s) 40 or of the anvil assembly 60, to reduce wear and tear on the components of the apparatus 100. The at least one bumper 70 may be of an elastic material, and may be disposed on the apparatus 100 at any position where it is capable of absorbing a portion of the force of impact by the piston(s) 42 or the anvil assembly 60.

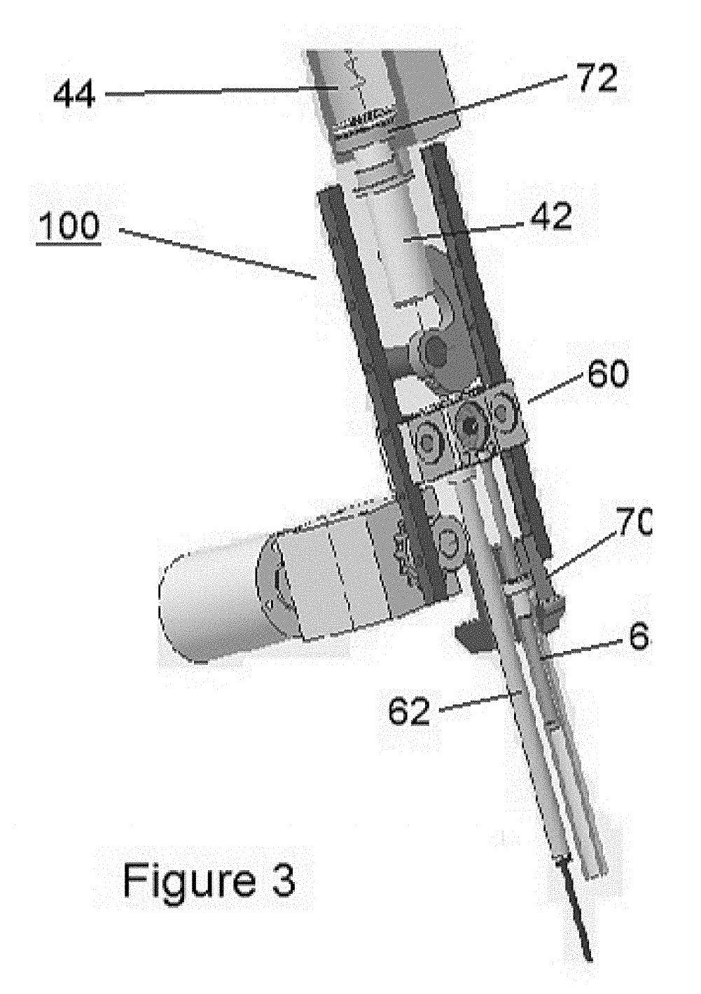

The anvil assembly 60 further comprises a return mechanism 64 to enable the anvil assembly 60 to return to a position where it can be again contacted or acted on by the gas springs 40. In an embodiment, the return mechanism 64 is a return energy storage means that is disposed on or in the guide or shaft that constrains the anvil assembly 60. The return mechanism 64 may comprise, in an embodiment, a mechanical spring, a gas spring or an elastomeric spring), which return mechanism would be disposed nearer the end or portion of the anvil assembly 60 that is distal to the gas spring(s) 40. In a preferred embodiment, the return mechanism may be a gas spring (as shown in FIG. 3.) After the gas springs 40 cause the anvil assembly 60 to move, and after or in connection with the anvil 62 impacting and driving a fastener, the return mechanism 64 imparts a force on the anvil assembly 60 to cause the anvil assembly 60 to return to a position where it may again be operatively acted upon by the gas springs 40. In the embodiment where the return mechanism 64 is a gas spring, the gas spring return mechanism may push or otherwise act on a tab or other element disposed on the anvil and/or anvil assembly to cause the anvil and/or anvil assembly to return to a position where it can again be operatively acted on by gas spring(s) 40.

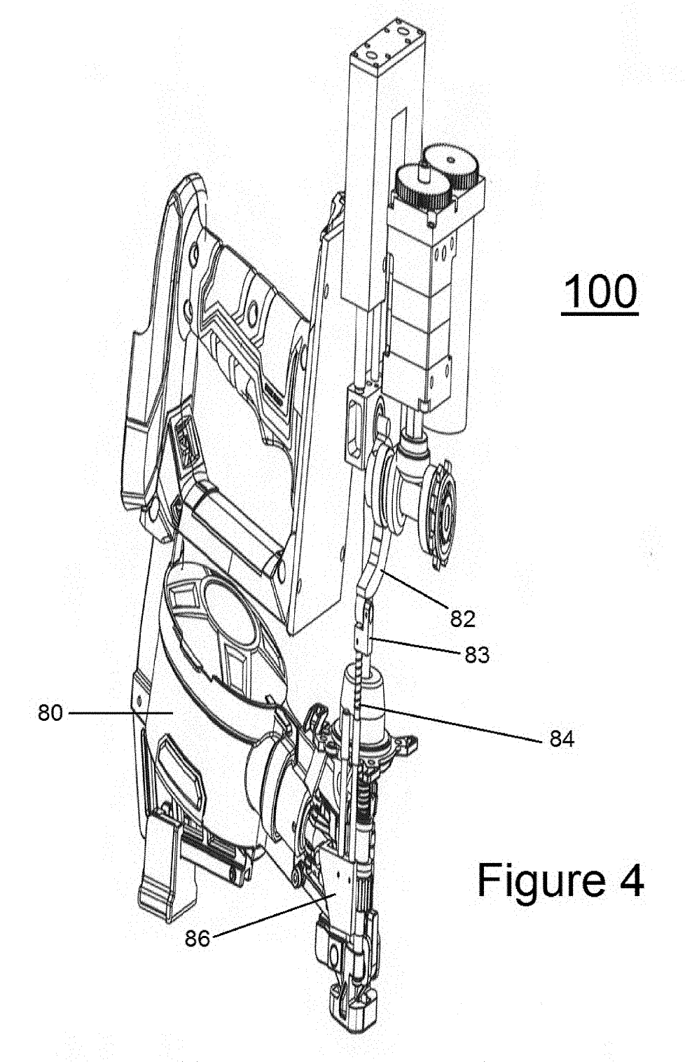

The apparatus may further comprise a nail indexing mechanism 80, as shown in FIG. 4. In an embodiment, the drive mechanism includes a cam 82 for indexing a nail in the apparatus. The cam motion and timing are used to feed nails, such as in a coil nailing system. In an embodiment, the cam motion is used to drive linkages 83 of the nail indexing mechanism to index a nail. In another embodiment, motion of the cam 82 may compress a spring 84 of the nail indexing mechanism, which spring 84 may then index a nail. In an embodiment, the cam of the drive mechanism may engage the anvil to energize the gas springs in one direction while simultaneously engaging a linkage to drive the nail indexing mechanism in the opposite direction. It will be apparent that these motions are out of phase such that the nail is indexed before the gas spring is released to drive the fastener.

In an embodiment, the cam 82 starts its rotation after start of the operational cycle and engages a linkage 83 of nail indexing mechanism 80. This motion moves the linkage 83 downward and retracts a feeding mechanism 86 of the nail indexing mechanism 80, compressing a spring of the feeding mechanism 86. As the cam 82 continues its rotation, full stroke of the linkage 83 of the nail indexing mechanism is achieved, and the cam releases the linkage. The linkage 83 of the nail indexing mechanism 80 may be biased by a spring that returns it to its start position. As the linkage 83 retracts, the feeding mechanism spring of the nail indexing mechanism 80 releases the feeding mechanism 86 and indexes the nail into position beneath the anvil assembly 60 and/or anvil 62.

The present disclosure offers the following advantages: the gas springs, mechanical springs and elastomers are capable of generating a relatively high amount of force in a small amount of space such that the size of the apparatus may be smaller than other fastener drivers. Further, because of the relatively small increase from the initial pressure in the gas spring during an energy storage cycle and the shapes of the cam, the motor can operate at a relatively constant torque during energy storage thus leading to a longer useful life of the apparatus. Furthermore, it was unexpectedly discovered that this disclosure has an improved safety profile. For example, if a nail becomes jammed, the potential energy of the gas spring(s) does not act directly on the fastener and thus while the user removes the fastener, there is reduced potential for injury. It was a further unexpected discovery of the present disclosure that the apparatus has an improved recoil force as opposed to conventional and or prior fastener disclosures. This was a totally unexpected discovery as the anvil/anvil assembly is a free traveling mass and as such during the course of the driving of the fastener does not put a reactionary force on the operator. In contrast and in prior art tools, air pressure or other force on the piston and anvil assembly often acts during the entire drive and can result in significant recoil to the operator.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A fastener driving apparatus, the apparatus comprising
a power source,
a control circuit,
a motor,
a drive mechanism,
an anvil assembly, said anvil assembly comprising an anvil,
at least one gas spring, said at least one gas spring comprising a chamber and a piston disposed within said chamber, said gas spring operationally coupled to said anvil assembly,
wherein said drive mechanism causes said anvil assembly to move from a first position to a second position to drive a fastener, and
wherein said gas spring thereafter returns said anvil assembly to said first position.

2. The fastener driving apparatus of claim 1, said apparatus further comprising a second gas spring, wherein said anvil assembly is moved from said first position to said second position to drive a fastener by said second spring.

3. The fastener driving apparatus of claim 2, wherein said second spring comprises two or more springs.

4. The fastener driving apparatus of claim 1, said fastener driving apparatus further comprising an energy storage means, wherein said anvil assembly is moved from a first position to a second position to drive a fastener by said energy storage means and wherein said gas spring thereafter moves said anvil assembly back to a first position.

5. The fastener driving apparatus of claim 4, wherein said piston of said piston weighs less than 20 grams.

6. The fastener driving apparatus of claim 5, wherein said piston comprises one of aluminum, magnesium and titanium.

7. A fastener driving apparatus, the apparatus comprising
a power source,
a control circuit,
a motor,
an energy storage means,
a drive mechanism, said drive mechanism capable of selectively engaging and disengaging said energy storage means, and said energy storage means capable of moving to an energized position, upon being engaged by said drive mechanism
a nail indexing mechanism,
and an anvil assembly, said anvil assembly comprising an anvil,
wherein said drive mechanism comprises an engagement region for engaging and causing said energy storage means to increase in potential energy and a non-engagement region wherein said drive mechanism ceases to increase the potential energy of said energy storage means,
wherein said drive mechanism comprises an engagement region for engaging said nail indexing mechanism to move said nail indexing mechanism to index a nail, and a non-engagement region for causing said nail indexing mechanism to cease moving.
wherein after potential energy is increased in said energy storage means and after said drive mechanism thereafter disengages said energy storage means, said energy storage means accelerates said anvil to drive a fastener.

8. The fastener driving apparatus of claim 7, wherein said nail indexing mechanism comprises at least one of a cam follower, a linkage and a spring.

9. The fastener driving apparatus of claim 7, wherein said energy storage means is one of a mechanical spring, gas spring, vacuum and compressed air.

10. A fastener driving apparatus, the apparatus comprising
a power source,
a control circuit,
a motor,
an energy storage means,
a drive mechanism capable of selectively engaging and disengaging said energy storage means, said energy storage means capable of moving to an energized position upon being engaged by said drive mechanism,
an anvil assembly, said anvil assembly comprising at least an anvil,
wherein said drive mechanism comprises an engagement region for engaging and causing said energy storage means to increase in potential energy and a non-engagement region wherein said drive mechanism ceases to increase the potential energy,
wherein after said drive mechanism disengages said energy storage means, said energy storage means accelerates said anvil assembly to drive a fastener and wherein said anvil assembly separates from said energy storage means for at least a portion of the fastener drive stroke.

11. The fastener drive apparatus of claim 10 wherein said drive mechanism has a clutch, said clutch capable of retaining said drive mechanism in an intermediate stoppage point before said drive mechanism disengages said energy storage means.

12. The fastener drive apparatus of claim 10, said apparatus further comprising a gas spring, wherein said anvil assembly is biased towards a first position by said gas spring.

13. The fastener driving apparatus of claim 10 wherein said drive mechanism includes a cam and spring arrangement for indexing a fastener.

14. The fastener driving apparatus of claim 10, wherein the energy storage means comprises a gas spring, said gas spring comprising a piston, and wherein the mass of said piston of the gas spring is less than 50% of the mass of the anvil assembly.

15. The fastener driving apparatus of claim 10, wherein the energy storage means includes one of a gas spring, mechanical spring or elastomeric spring.

16. The fastener driving apparatus of claim 10, wherein said drive mechanism comprises one of a cam and a rack and pinion.
